(19) United States
(12) Patent Application Publication
(10) Pub. No.: US 2002/0065736 A1
(43) Pub. Date: May 30, 2002

(54) Electronic procurement system

(76) Inventors: David Willner, Manhasset, NY (US); John Petherbridge, Bethpage, NY (US); Rudolph Krepela, Marlboro, NJ (US); Anne Beauvil, Jamaica, NY (US); Daniel Lindsay, Bronx, NY (US); Rosaria Borrometi, Brooklyn, NY (US); Salvatore Boccio, Staten Island, NY (US); Irina Rombom, Edison, NJ (US); Dan Griffin, Bronx, NY (US); Stuart Schnapp, Park Ridge, NJ (US); Eric Abramson, New York, NY (US)

Correspondence Address: FITZPATRICK CELLA HARPER & SCINTO, 30 ROCKEFELLER PLAZA, NEW YORK, NY, 10112, US

(21) Appl. No.: 09/863,109

(22) Filed: May 22, 2001

Related U.S. Application Data
(60) Provisional application No. 60/206,586, filed on May 23, 2000.

(51) Int. Cl. G06F 17/60

(52) U.S. Cl. 705/26; 705/28

(57) ABSTRACT

An electronic procurement system connected to a network enables employees of an organization to electronically order goods directly from vendors. The system includes an electronic memory storing a vendor's catalog of items available for purchase, a transmitter, operatively connected to the network and to an external network, for electronically transmitting a purchase order from the system to a vendor via the external network, and a comparison unit. A record of the purchase order is stored in the memory of the system and the comparison unit compares an invoice received from the vendor with the record to determine whether there are any discrepancies.

### CROSS-REFERENCE TO RELATED APPLICATION

The present application claims benefit of U.S. Provisional Application No. 60/206,586 filed on May 23, 2000, the entire contents of which is incorporated herein by reference.

### BACKGROUND OF THE INVENTION

1. Field of the Invention

The present invention relates generally to an electronic procurement system. More particularly, the present invention relates to a computerized system for ordering goods and/or services via an organization's internal computer network.

2. Related Art

In a large decentralized organization that has numerous branch sites and even more numerous field sites, the ordering of goods and services generally is routed through a main purchasing department of the organization, and is usually a time-consuming process. For example, in order to purchase a toner cartridge for a laser printer, an employee of the organization would have to provide detailed information on a purchase request form, including information such as the manufacturer and model number of the printer, so that a buyer in the purchasing department would know exactly what to purchase.

The buyer would then place an order with a contracted vendor for the toner cartridge. Because of the time involved in such a paper process, the employee may not receive the toner cartridge for a week, if not longer, and such a delay usually necessitates the stockpiling of extra toner cartridges in case a printing emergency arises. In addition, the purchasing department has to maintain a sufficiently large staff to process all the purchase requests from the various sites in a timely manner to prevent additional delays caused by backlogs.

Another aspect of conventional procurement processes is the large amount of human capital required to take care of backend operations, where orders that have been placed are matched, or reconciled, with invoices from vendors and also with shipping papers. Such back-end operations are necessary to assure that the orders that have been placed have been fulfilled by the vendors, and that the vendors' invoices properly reflect the received orders. Conventional reconciliation processes are performed manually, which can be very time consuming, because invoice formats do not always correlate with purchase order formats or with shipping list formats. Further, items in a purchase order are not always shipped together, thus further complicating reconciliation of invoices with purchase orders and shipping lists.

In view of the above considerations, it is desirable to have an automated procurement system in which human intervention is minimized for at least the standard, essential aspects of the procurement process.

### SUMMARY OF THE INVENTION

An object of the present invention is to provide an electronic procurement system used by an organization to enable its employees to order standard commodity goods, equipment, and services, necessary to perform their jobs, with minimal intervention of a buyer from the organization's purchasing department.

According to the invention, a network interconnects a plurality of sites of an organization to an electronic procurement (e-procurement) system. The network may be, for example, an internal network of the organization (intranet) or a publicly accessible network (Internet). Employees authorized to access the system can peruse various catalogs containing descriptions of items that can be purchased, and can electronically indicate which items from the various catalogs are to be purchased.

According to one aspect of the invention, catalogs of one or more vendors are stored in an electronic memory accessible via a network, such that employees authorized to access the e-procurement system may view the catalogs' contents. In a preferred embodiment, the catalogs are not accessible by the vendors and, therefore, may not be altered without prior approval of the purchasing organization. That is, catalog items, prices, and descriptions cannot be arbitrarily changed by the vendors, and can only be changed with special permission granted by the purchasing organization, or when scheduled catalog revisions are due.

According to another aspect of the invention, only employees with predetermined access codes are allowed to access the e-procurement system via the network. Each access code may be associated with a respective employee or may be shared by a group of two or more employees. The access codes are linked to the purchasing organization's personnel information of the respective employees, and can be used to identify purchasing information of each employee, including location, spending limits, categories of items that may be purchased, quantity limits, categories of items that are restricted, and previously purchased items, for example.

According to yet another aspect of the invention, items electronically selected for purchase either are approved by the e-procurement system because they satisfy predetermined purchasing criteria corresponding to the access code, or are forwarded via the network to an authorization mailbox. An employee with greater purchasing authority will review purchase requests in the mailbox and authorize the purchase of appropriate items. If authorization is not given, the reasons for rejection are e-mailed to the requester via the network. Thus, another level of security beyond the access code is given to non-standard purchase requests.

According to a further aspect of the invention, once a purchase request is approved, an order is transmitted electronically to the vendor whose catalog item is selected. The electronic order is sent using known methods, such as EDI (Electronic Data Interchange), FTP (File Transfer Protocol), and XML (Extended Markup Language), and a record of the order is stored in the e-procurement system. The organization's e-procurement system is transparent to the vendor. That is, the vendor need not have any knowledge of how the e-procurement system is run. In due course, the vendor electronically transmits an invoice to the purchasing organization.

The e-procurement system then undergoes an automatic electronic reconciliation process, in which the invoice is compared with the stored record of the order on an item by item basis. If an invoice entry differs from the corresponding order entry, the entry is electronically flagged so that the organization's purchasing department and/or accounting department is automatically notified of the discrepancy. Further, only items that have been indicated as having been received are electronically flagged for automatic payment. The organization's accounting department electronically receives an authorization to pay for those flagged items, thus minimizing human intervention.

According to another aspect of the invention, the e-procurement system uses an employee's purchasing history to perform a compatibility check on requested items. This prevents the inadvertent purchase of items that are incompatible with the employee's known previous purchases. For example, the e-procurement system would prevent an employee who previously purchased a “Model A” cellular telephone from ordering a “Model B” telephone battery.

According to yet another aspect of the invention, the e-procurement system includes an asset management feature, in which a request for the purchase of equipment is first checked against a list of the organization's surplus inventory, thus enabling better usage of existing assets. If inventory is available, appropriate steps are taken. In one embodiment, the purchase request is declined. In another embodiment, the requester is notified of the availability of the surplus inventory, and processing of the purchase request by the e-procurement system is temporarily suspended. If the requester accepts transfer of the surplus inventory matching the purchase request, the requester's e-procurement record is updated accordingly, and the purchase request is canceled. If transfer of the surplus inventory is rejected, the purchase request proceeds in the usual manner discussed above. Optionally, if a match is found between a surplus inventory item and a requested item, the requester may not reject transfer of the item without additional authorization.

According to a further aspect of the invention, changes to the e-procurement system are made at a central server of the organization, and no changes are required to be made at the employees' terminals or at the vendors' systems.

According to another aspect of the invention, employees with access to the e-procurement system may set up one or more electronic “baskets,” each consisting of a combination of items commonly purchased as a group, so that those items will not have to be individually designated each time the combination is to be purchased.

According to yet another aspect of the invention, an employee with access to the e-procurement system may set up a list of frequently purchased items, so that those items can be easily requested without having to use the electronic catalogs. optionally, the e-procurement system may set up such a list for each employee based on the employee's history of purchases.

It is to be understood that the present invention encompasses, but is not limited to, a system, an apparatus, a method, a computer program product, and a computer-readable storage medium storing a program for implementing the above-described aspects.

### BRIEF DESCRIPTION OF THE DRAWINGS

The present invention will be more readily understood from a detailed description of the preferred embodiments taken in conjunction with the following figures.

FIG. 1 schematically illustrates an e-procurement system according to an embodiment of the present invention.

FIG. 2 illustrates a logon screen displayed at an employee's terminal.

FIG. 3 illustrates a “caveat emptor” screen.

FIG. 4 illustrates a bookkeeping screen.

FIG. 5 illustrates a product menu screen.

FIG. 6A illustrates a product menu subcategory screen; and

FIG. 6B illustrates a detailed list of items within a subcategory of the screen shown in FIG. 6A.

FIG. 7 illustrates a shopping cart screen.

FIG. 8 illustrates a final order screen.

FIG. 9 illustrates an order entry screen.

FIG. 10 illustrates a product search screen.

FIG. 11 illustrates a screen listing search results.

FIG. 12 illustrates an order status screen.

FIG. 13 illustrates an order search screen.

FIG. 14 illustrates a screen listing baskets of items.

FIG. 15 illustrates a screen listing items within designated baskets.

FIG. 16 is a flow chart illustrating an approval process according to an embodiment of the present invention.

### DETAILED DESCRIPTION OF PREFERRED EMBODIMENTS

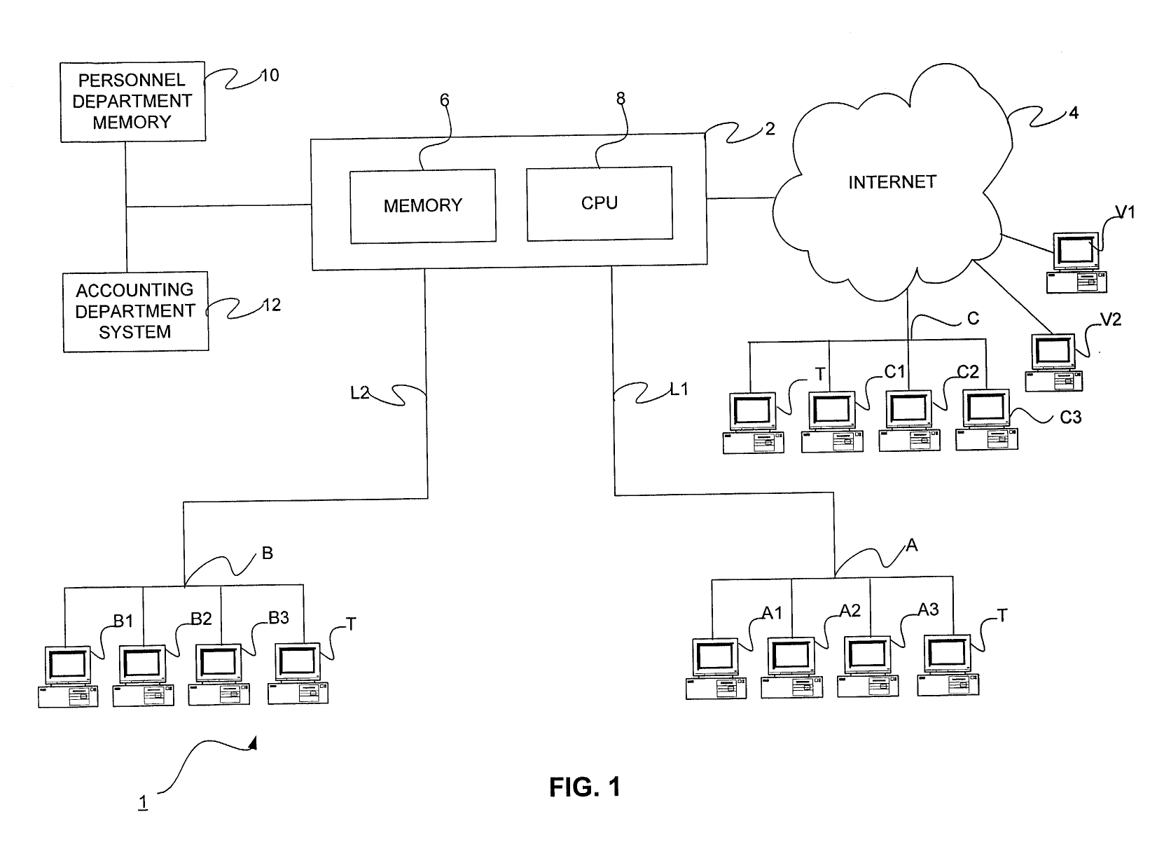

FIG. 1 illustrates an e-procurement system 1 according to the present invention. The e-procurement system 1 includes a central processing system 2 connected to an organization's computer networks A, B, C via dedicated lines L1, L2 or via the Internet 4. The central processing system 2 is any computer system that has, among other things, a memory 6 and a central processing unit 8 sufficient to handle the organization's purchasing requirements. Preferably, the central processing system 2 is a mainframe computer system.

The central processing system 2 is connected to one or more vendor systems V1, V2 via the Internet 4. Catalogs and price lists are downloaded from the vendor systems V1, V2, and are stored in the memory 6 of the central processing system 2. Once stored in the memory 6, the catalogs and the price lists cannot be altered by the vendor systems V1, V2. This prevents the vendors from modifying the descriptions of items in the catalogs, adding or deleting items, and changing prices without the organization's knowledge and approval. The organization, however, can modify the catalogs to, for example, delete items that are not appropriate for the organization, and can modify the price lists to reflect, for example, discount prices agreed upon by the vendors for their preferred customers.

Optionally, the vendors may update their catalogs and/or price lists with special permission from the organization or at regularly scheduled update periods. In such cases, the updated catalogs and/or price lists are downloaded from the vendor systems V1, V2 and are substituted for the old catalogs and/or price lists stored in the memory 6. Because the e-procurement system 1 is centrally controlled by the central processing system 2, any modifications to the operation of the e-procurement system 1 need only be made at the central processing system 2, and not at employee terminals or at vendor systems.

Employees of the organization authorized to make purchases using the e-procurement system 1 are provided with access codes. An access code enables an employee to access the e-procurement system 1 from any of the terminals A1-A3, B1-B3, C1-C3 connected to the central processing system 2 either directly, via the dedicate lines L1, L2, or indirectly, via the Internet 4. It should be understood that the terminals A1-A3, B1-B3, C1-C3 include means for inputting data, such as a keyboard, a pointing device (mouse, touchpad), an a voice recognition unit, for example.

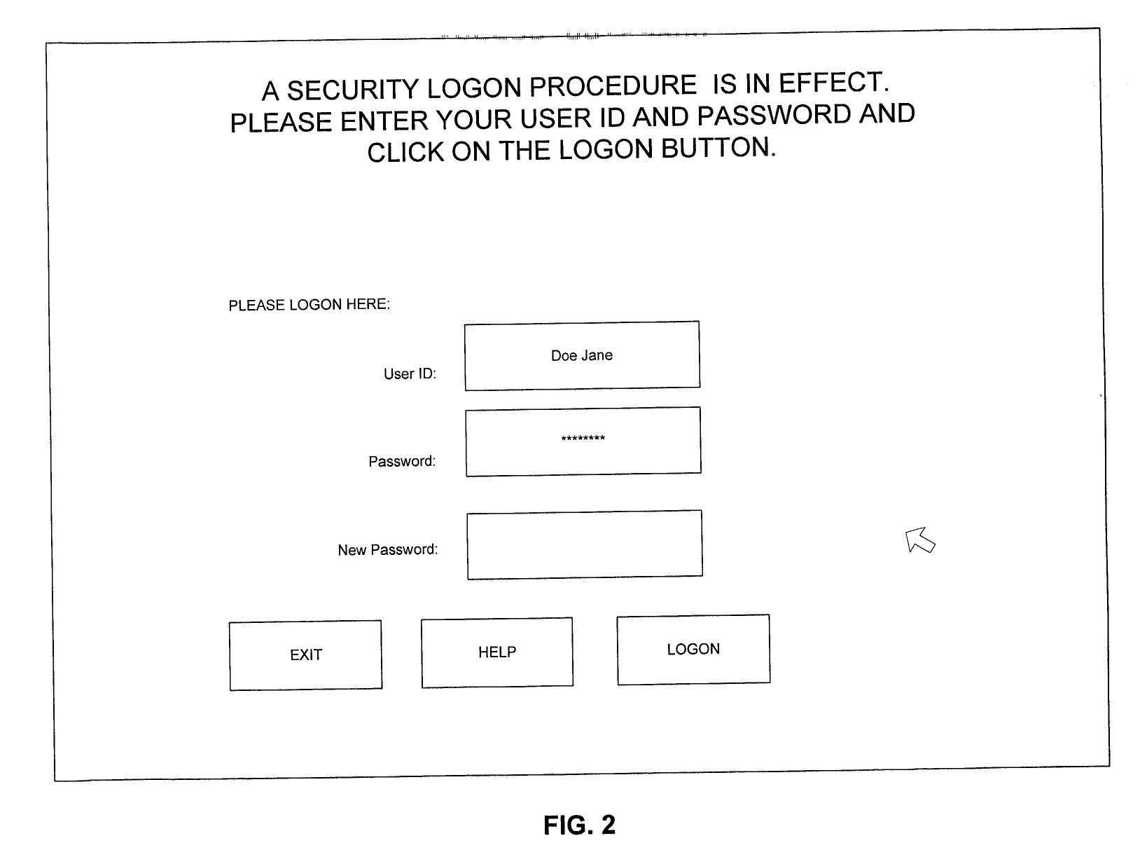

FIG. 2 schematically illustrates a logon screen displayed at a terminal when an employee tries to access the e-procurement system 1. The screen requests input of the employee's user#ID and an access code (password). If the inputted access code matches the access code stored in the memory 6 for the inputted user#ID, then the employee is allowed to input a purchase request. If not, the employee is prompted to contact the organization's personnel department to resolve any questions about the inputted user#ID and/or access code.

Optionally, an access code may be shared by more than one employee. For example, a single access code with very restricted purchasing authority may be given to the organization's consultants (contract employees). This minimizes the number of access codes that the central processing system 2 must process.

As shown in FIG. 1, the central processing system 2 is connected to a memory 10 of the organization's personnel department. This enables the central processing system 2 to acquire purchasing information regarding the employee, including information on the employee's location, spending limits, and previously purchased items, as well as information on categories of items that may be purchased, quantity limits, and categories of items that are restricted from purchase.

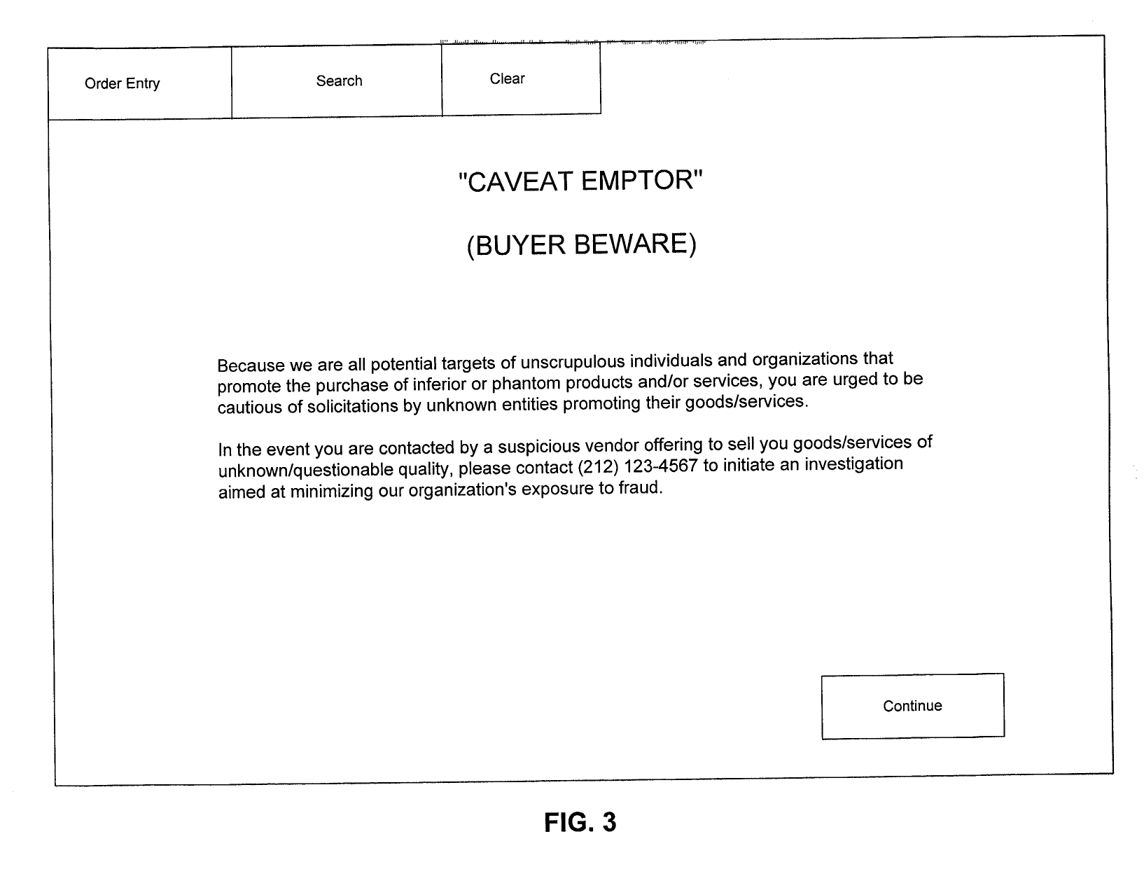

Once the employee is granted access to the e-procurement system 1, the terminal displays a “caveat emptor” or “buyer beware” screen, such as shown in FIG. 3. This screen warns the employee of various fraudulent practices of imposters posing as vendors, and what to do if the employee receives questionable solicitations. Optionally, this screen may be used to warn the employee of any products recalled by their manufacturers, as well as other alerts. The “caveat emptor” screen appears only once, and appears each time the employee gains access to the e-procurement system 1.

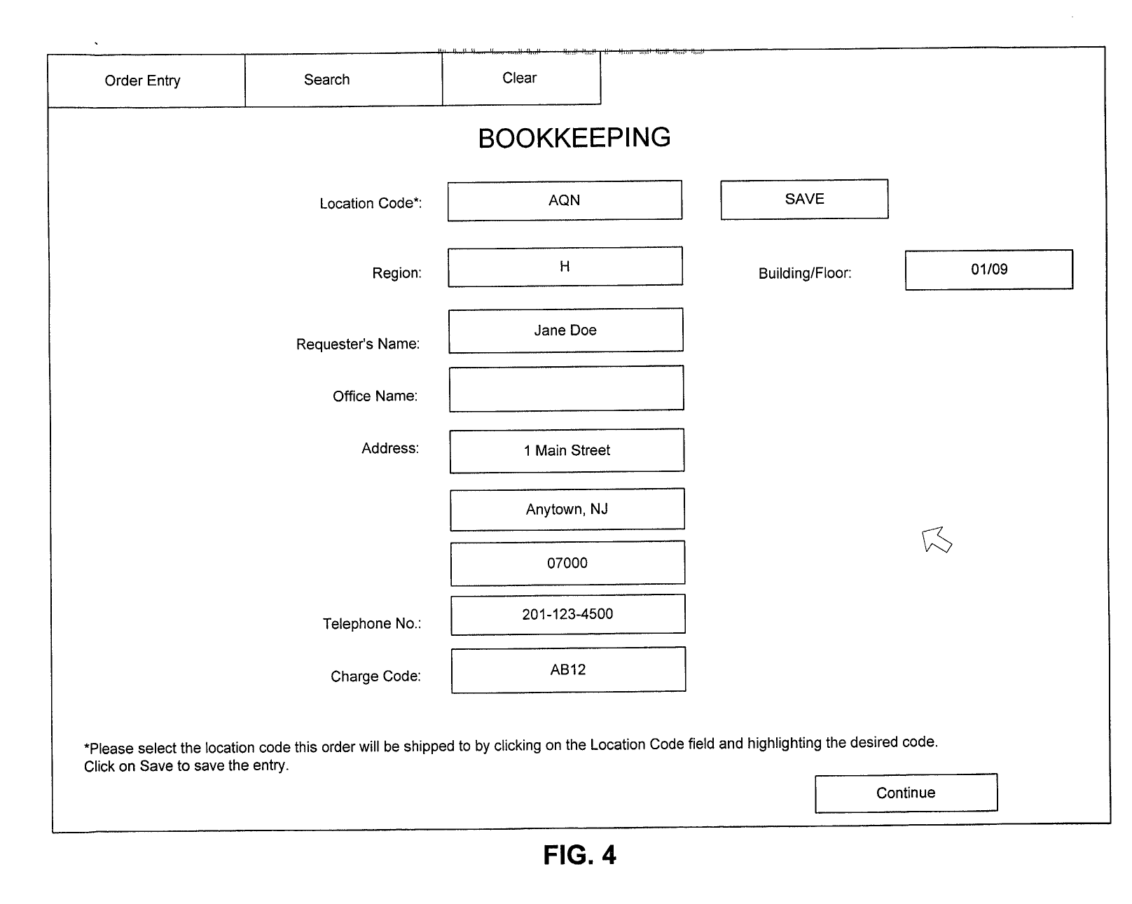

To continue with the purchasing procedure after the “caveat emptor” screen appears, the employee clicks on a “continue” button on the screen. At that time, the terminal displays a bookkeeping screen, as shown in FIG. 4. This screen indicates the employee's purchasing information obtained from the memory 10 of the organization's personnel department via the central processing system 2. The bookkeeping screen shows information such as the employee's location code and region, which indicate the geographic region where the requested items are to be shipped. If applicable, the employee's building and floor are indicated on this screen. This feature is especially beneficial for an organization that has numerous branch offices in various locations, and allows the organization to maintain a centralized purchasing department instead of requiring separate purchasing departments for each of branch.

The bookkeeping screen also shows the employee's (requester's) name, address, and telephone number, and a charge code, which indicates a project to which the requested items are to be billed. Optionally, other relevant contact information may be displayed on this screen.

The fields displayed on the bookkeeping screen may be changed. That is, if the employee is authorized to make purchases for a location other than the default location indicated in the employee's purchasing information stored in the memory 10 of the organization's personnel department, the employee may change the location code shown on the bookkeeping code screen by clicking on the location code field and inputting a new location code using the terminal's keypad, for example. If the employee is authorized to make purchases for more than one project, the charge code field may be clicked on and changed. Other fields in the bookkeeping screen may be changed in a similar manner. If an invalid entry is inputted, that is, an entry not recognized by the central processing system 2, the employee is prompted to correct the entry or contact the organization's personnel department to resolve any questions about the entry.

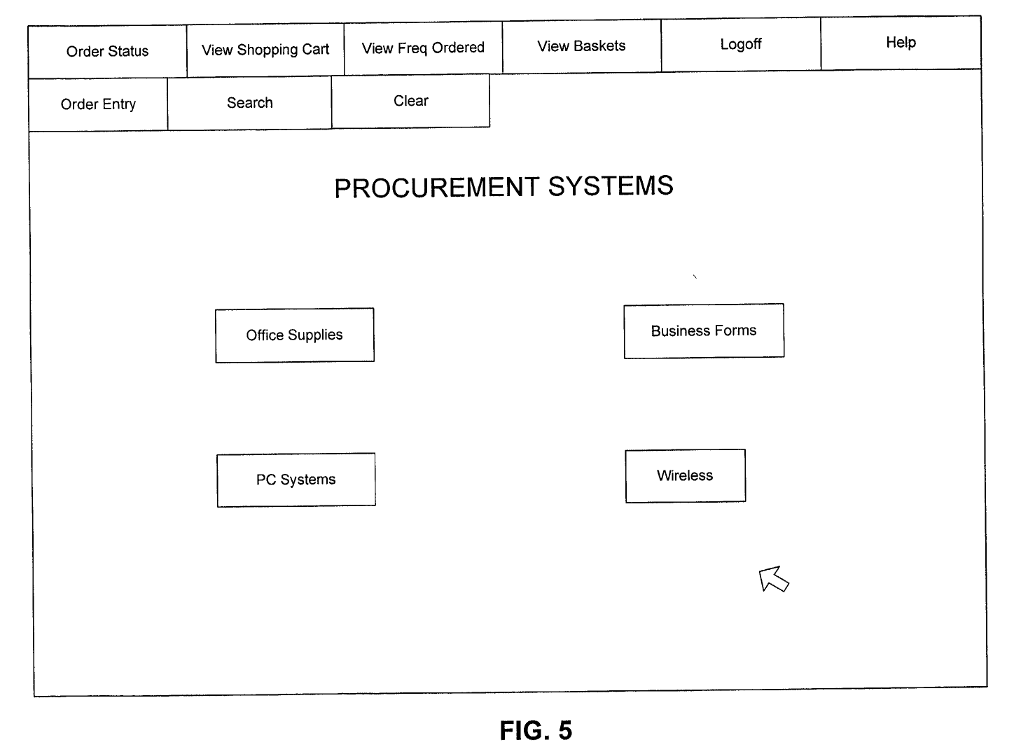

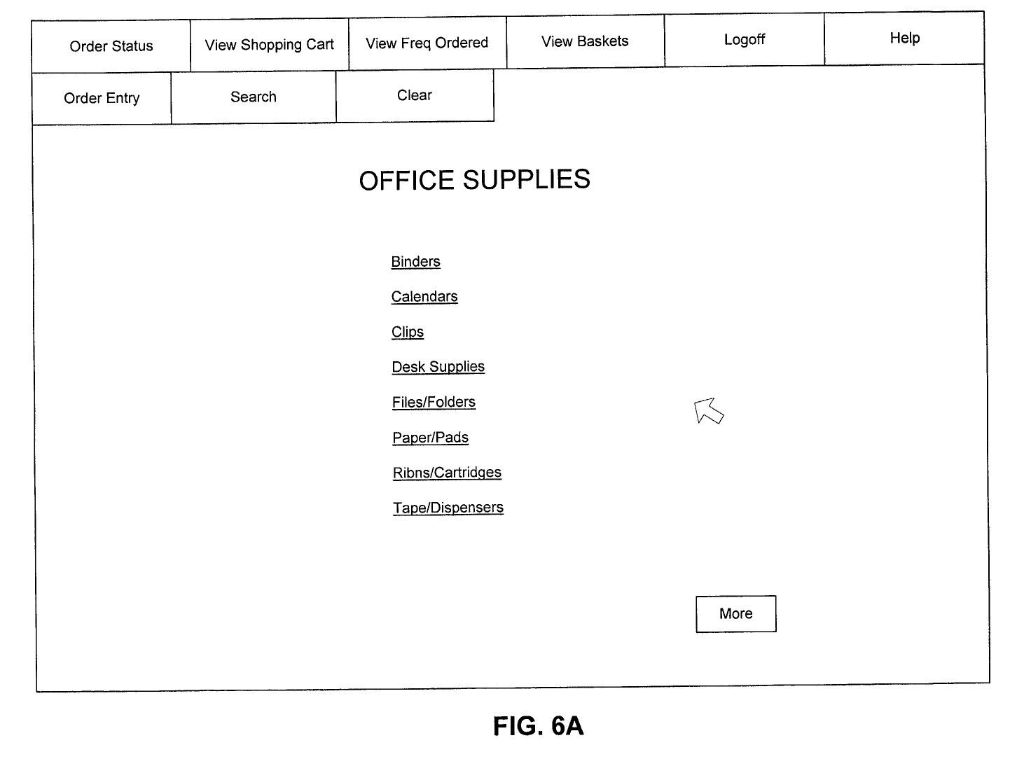

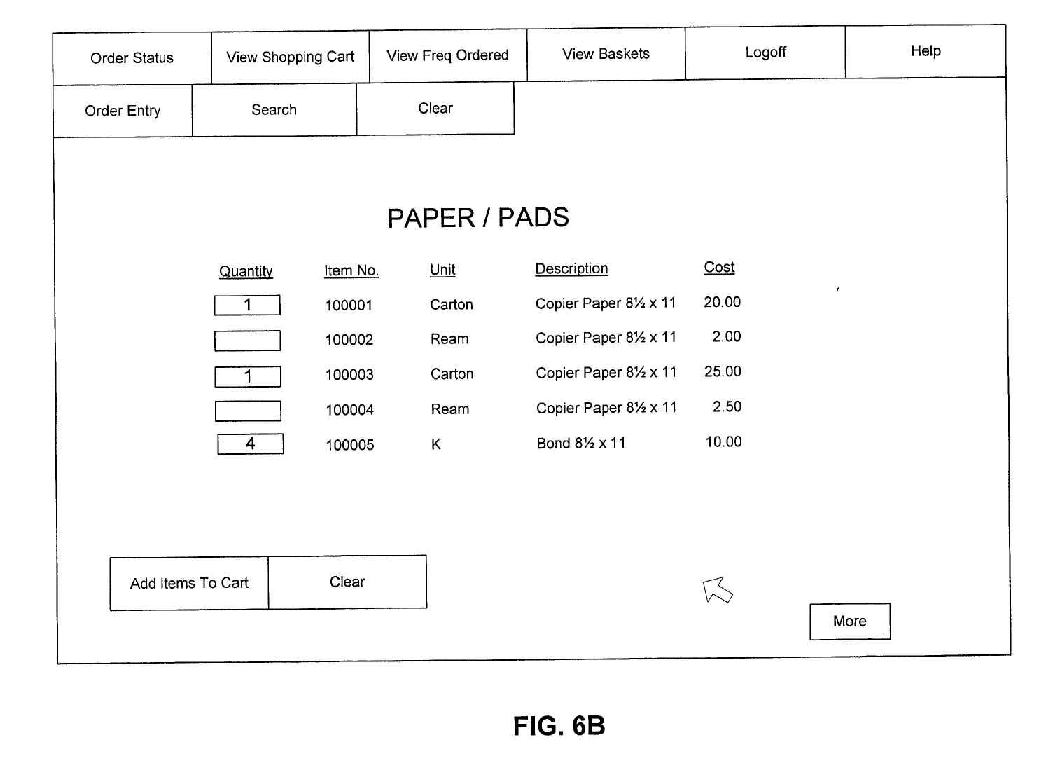

After the bookkeeping screen is completed, the terminal displays a product menu screen, schematically shown in FIG. 5. This screen allows the employee to select from a list of product categories, including, for example, office supplies; business forms; PC systems; hardware; software; manuals; facsimile; cellular; and pager. If the office supplies category is selected, the terminal displays a screen showing subcategories of office supplies, including, for example, binders; calendars; clips; desk supplies; files/folders; paper/pads; pens/markers; ribbons/cartridges; staplers/staples; and tape/dispensers, as shown in FIG. 6A. By clicking on a subcategory, a detailed catalog of items available for purchase is displayed on the terminal's screen, as shown in FIG. 6B.

The product menu mode is the default purchasing mode of the purchasing procedure. If, however, the employee knows the exact catalog numbers for the items to be purchased, then the employee may choose the order entry mode, which is described below. Similarly, the employee may search for particular items in the search mode, which is described below.

In the product menu mode, the employee peruses various product catalogs stored in the memory 6 of the central processing system 2 from the terminal. An item is selected for purchase by clicking on the desired item. The employee is then prompted to input the quantity of the item to be purchased, and whether to add the item to a shopping cart. The contents of the shopping cart can be viewed by clicking on the “View Shopping Cart” button displayed on each of the product menu screens (FIGS. 5, 6A, and 6B, for example), at which point the terminal displays a shopping cart screen.

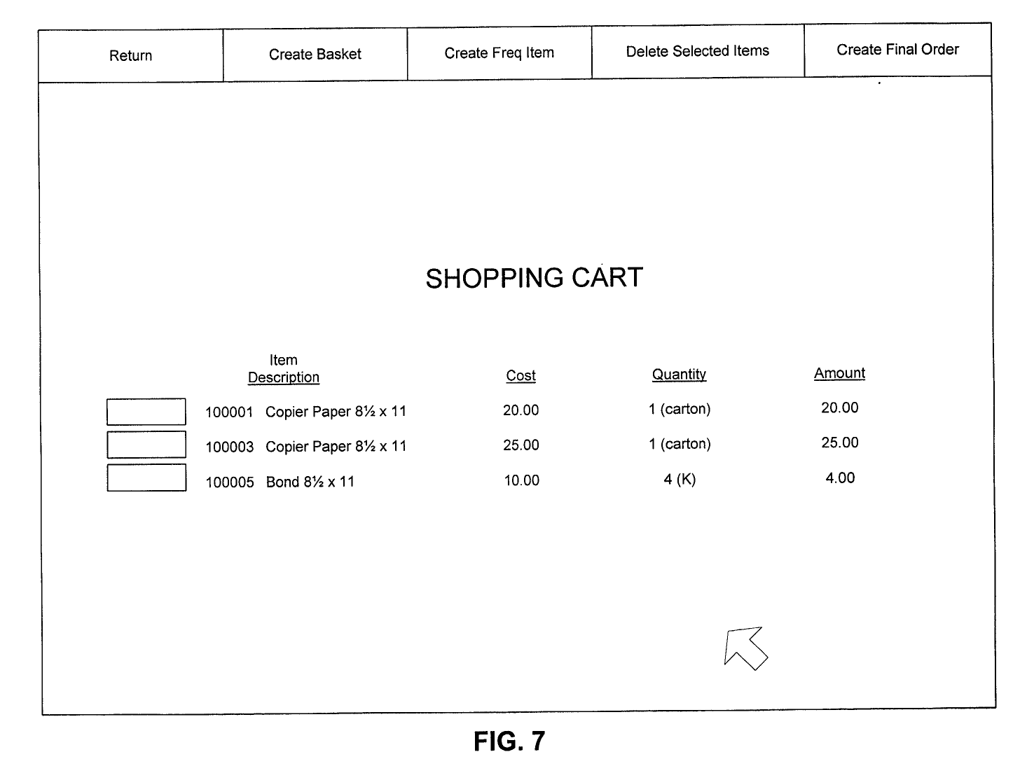

As shown in FIG. 7, the shopping cart screen lists information regarding the items selected for purchase, including item number, item description, cost, quantity, and amount (total cost). An item may be deleted from the shopping cart by selecting it with the terminal's pointing device, and then clicking on the “Delete Selected Items” button displayed on the shopping cart screen. If the employee has not finished designating items for purchase, the “Return” button may be clicked on to return to the previously displayed screen.

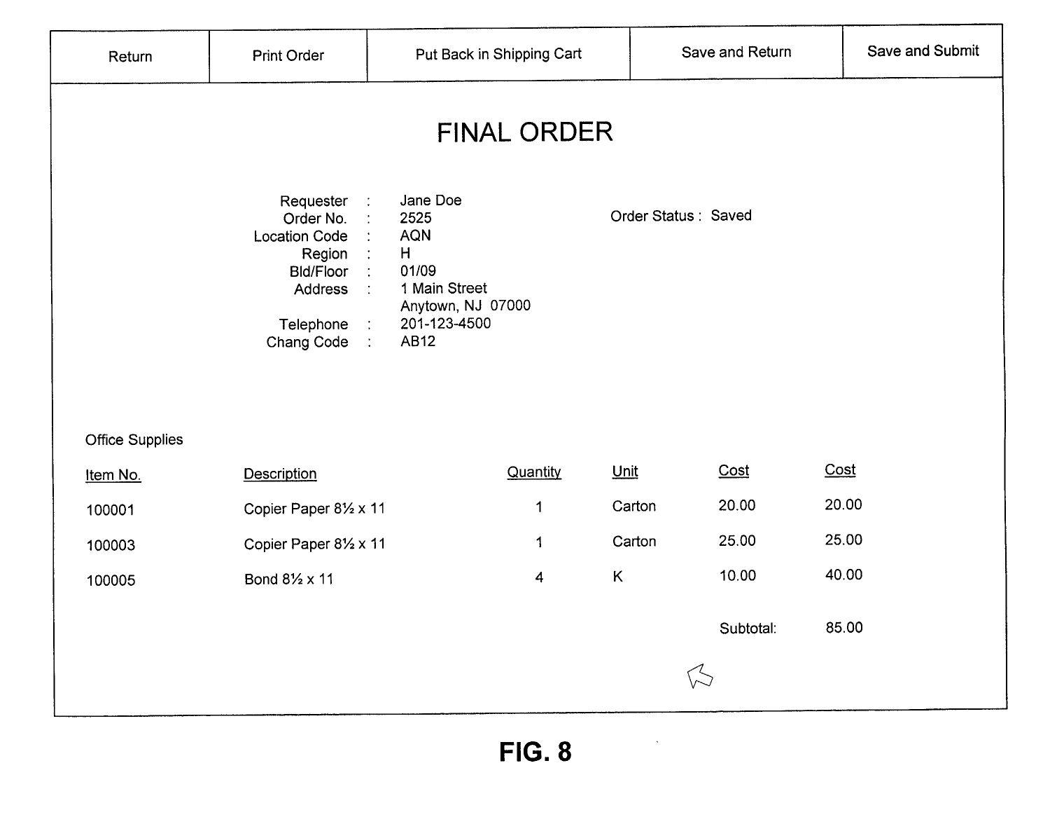

If no other items are to be designated for purchase except those displayed on the shopping cart screen, a final order of those items is created by clicking on the “Create Final Order” button. This action appends the employee's purchase information and an order number to the order, as shown in FIG. 8. The employee can then save the order, so that it can be submitted at a later time, or submit the order and save a copy of the order for future reference. Optionally, the employee may put the items back in the shopping cart and continue designating items for purchase.

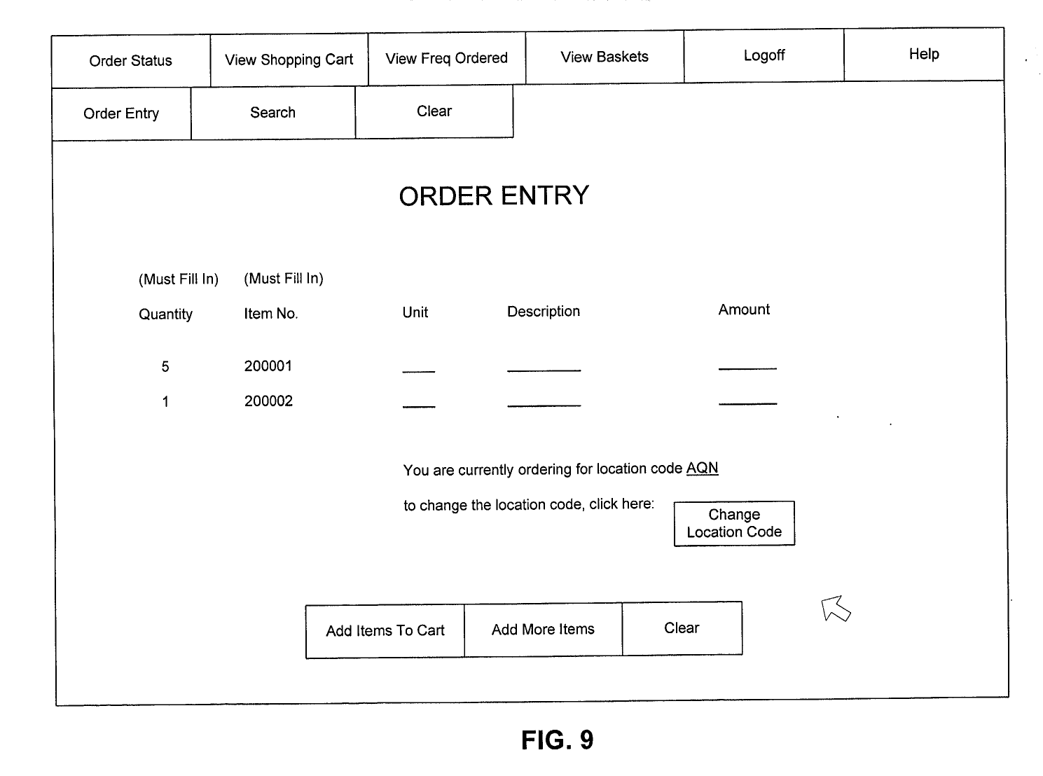

As mentioned above, if the employee knows the exact catalog numbers for the items to be purchased, then the employee may choose the order entry mode by clicking on the “Order Entry” button, as shown in the product menu screen of FIG. 5, at which point the terminal displays an order entry screen such as the one shown in FIG. 9. This screen has blank fields for the employee to input the catalog number and quantity of each item to be purchased. After the item information is inputted using the order entry screen, the employee may add the items to a shopping cart and proceed as described above. Before the shopping cart screen is displayed, a box requesting the employee to confirm the inputted entries appears that includes descriptions of the entries. This helps to prevent erroneous orders due to typographical errors.

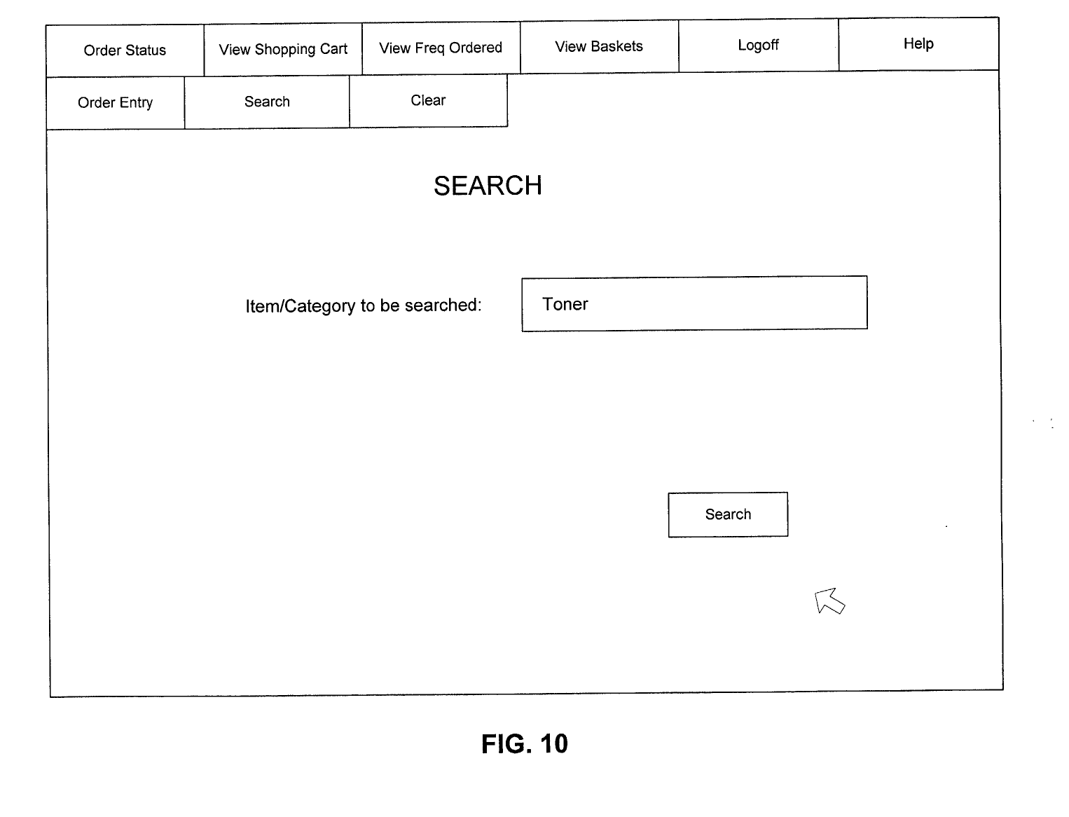

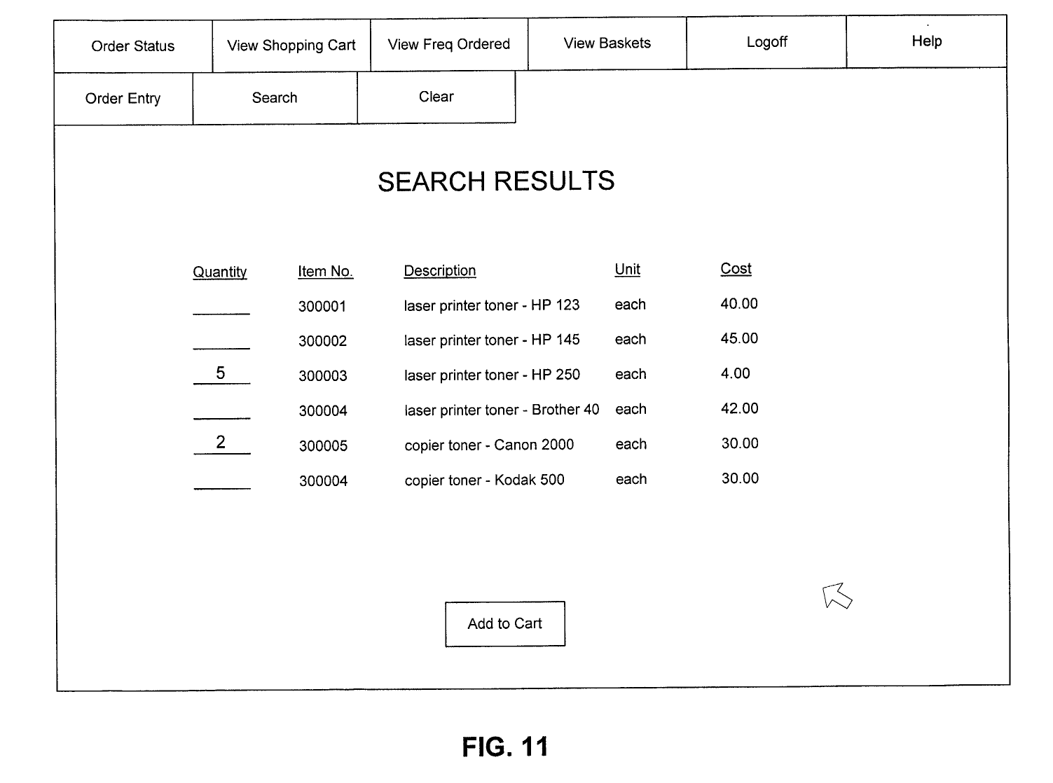

Further, as mentioned above, if the employee wants to search for a desired item to be purchased, then the employee may choose the search mode by clicking on the “Search” button, as shown in the product menu screen of FIG. 5, at which point the terminal displays a search screen such as the one shown in FIG. 10. This screen has a field for the employee to input a category to be searched. For example, if the term “toner” is input, the central processing system 2 searches its memory 6 for all listings of toner, and returns a search result screen such as the one shown in FIG. 11. The employee then inputs a quantity next to an item to be purchased. No quantity is designated for items that are not to be purchased. After the quantity information is inputted using the search result screen, the employee may add the items to a shopping cart and proceed as described above.

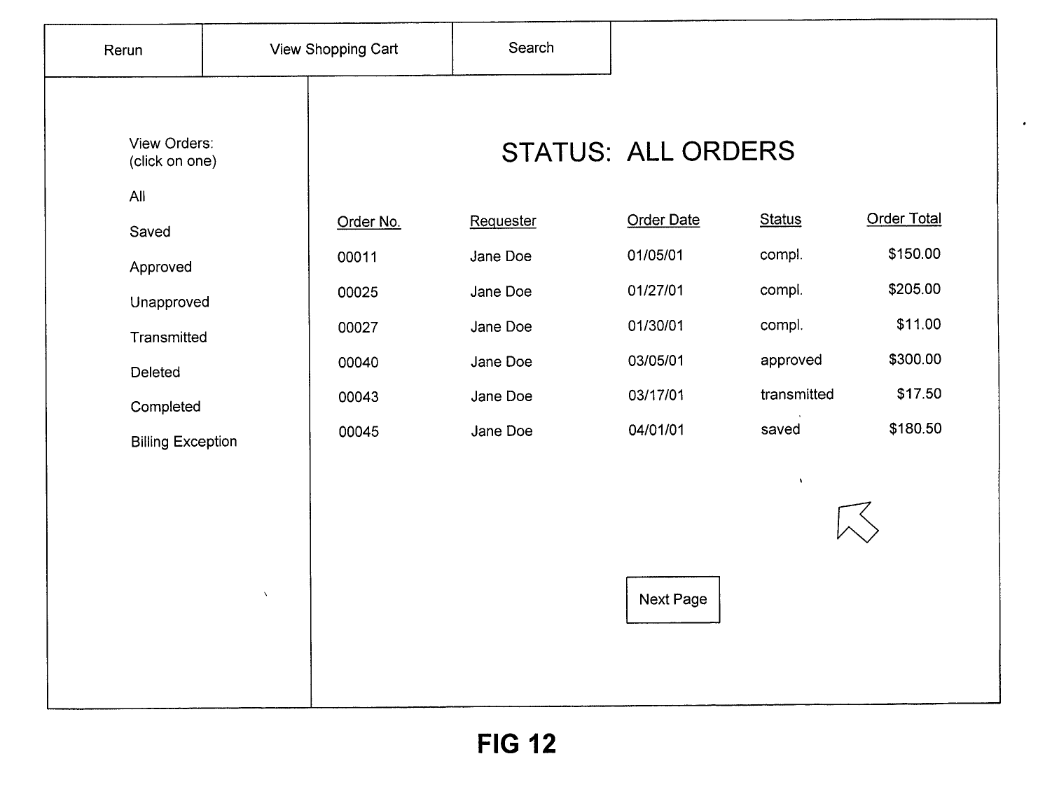

Once the e-procurement system 1 has been accessed, the employee may look at the order status of previously submitted orders by clicking on the “Order Status” button, as shown in the product menu screen of FIG. 5, at which point the terminal displays an order status screen such as the one shown in FIG. 12. This screen lists the employee's previous orders by order number, and also includes information such as order date, status, and the total cost of the order. The order status screen shown in FIG. 12 lists all of the employee's orders. Optionally, as shown on the left side of FIG. 12, the employee may choose to view subcategories of orders, such as saved orders, approved orders, unapproved orders, transmitted orders, deleted orders, completed orders, and billing exceptions, for example. The billing exceptions subcategory refers to a discrepancy in one or more items of the order. The discrepancy can relate to pricing, quantity, and invoiced items that were not in the original order.

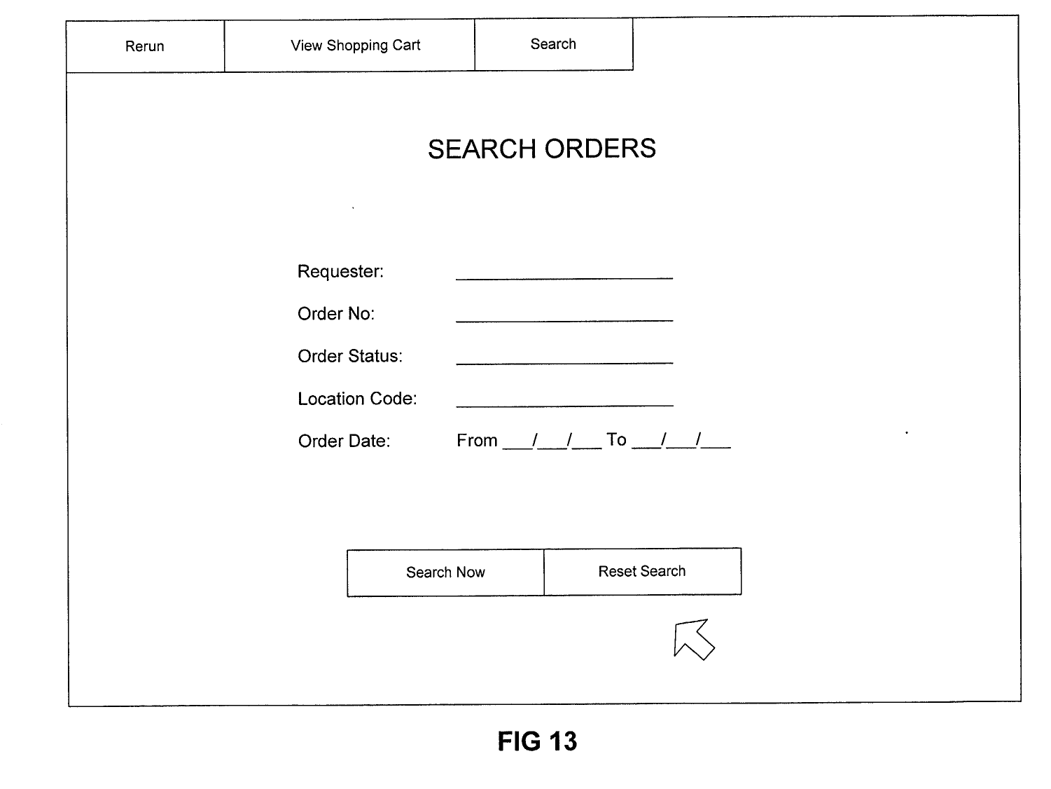

By clicking on the “Search” button while the order status screen is displayed, the employee may search for a particular order using inputted search parameters. For example, as shown in FIG. 13, the employee may search for all orders made on a particular date, a particular order number, and/or orders made under a particular location code for a range of dates.

For groups of items that are usually ordered together, the employee may create a “basket” of those items. To do this, the employee selects items listed on the shopping cart screen by highlighting (clicking on) those items and then clicking on the “Create Basket” button, as shown in the shopping cart screen of FIG. 7. The employee will then be prompted to designate whether a new basket is to be created for the items or whether the items are to be added to an existing basket. If a new basket is to be created, the employee will be prompted to input a name for the basket. If the items are to be added to an existing basket, the employee will be prompted to input the basket's name.

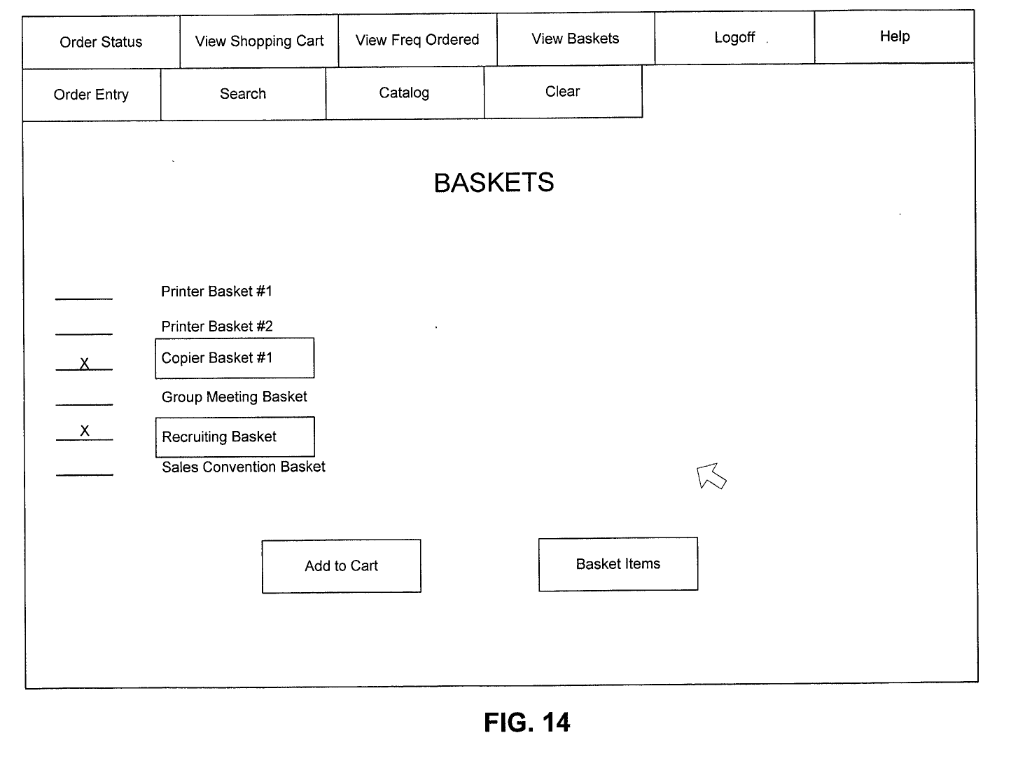

Once a basket has been created, the employee can by-pass the usual purchasing procedure of inputting information for each item to be purchased, and merely has to click on the “View Baskets” button in the product menu screen, as shown in FIG. 5. At this point, the terminal displays a list of names of baskets created by the employee, as shown in FIG. 14. One or more of the baskets can be designated for purchase by adding them to a shopping cart and proceeding in the same manner as discussed above.

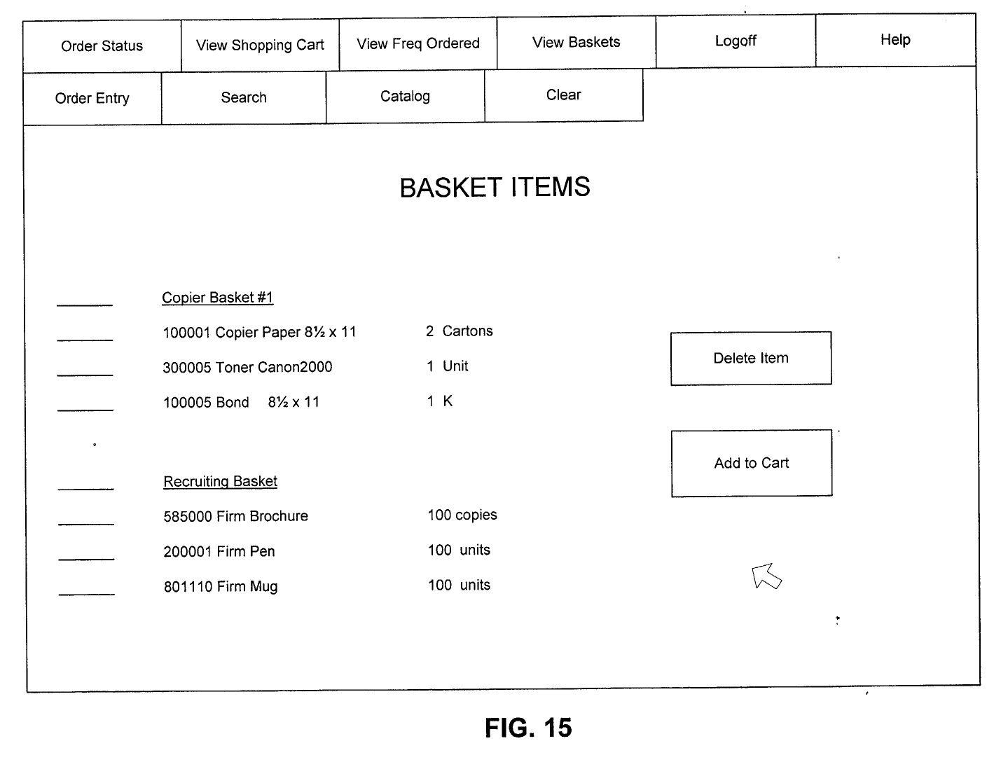

If the employee is unsure of the contents of a basket, clicking on the “Basket Items” button while that basket is selected (highlighted) causes a list of the items in that basket to be displayed, as shown in FIG. 15. The employee may then delete items from the basket, or may select some, but not all, of the basket items for purchase.

The employee may also create a list of frequently ordered items by highlighting those items in the shopping cart screen of FIG. 7 and then clicking on the “Create Freq Item” button. This procedure is also used to add items to the frequently ordered items list.

To order a frequently ordered item, the employee clicks on the “View Freq Ordered” button in any of the bookkeeping screen of FIG. 4, the product menu screen of FIG. 5, and the order entry screen of FIG. 9, for example, which causes a list of items the employee previously designated to be frequently ordered to be displayed on the terminal screen. Optionally, because the central processing system 2 keeps track of the employee's previous purchases, a list of the employee's most frequently purchased items also appears.

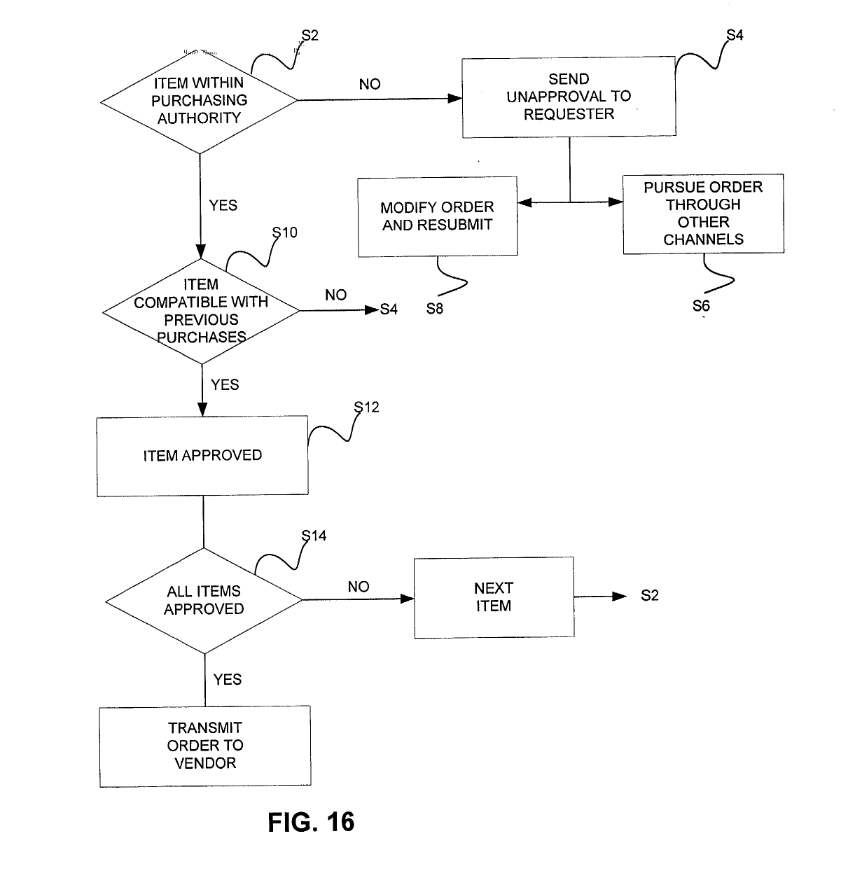

Once a final order is submitted for purchase, the order goes through an approval process. The approval process, in general, is automated, and requires human intervention by the organization's purchasing department only for non-standard purchases. FIG. 16 shows a flow chart of the approval process. In step S2, the central processing system 2 checks whether the items requested for purchase are within the employee's purchasing authority. This is done by accessing the employee's purchasing information from the memory 10 of the personnel department.

The final order is compared with the purchasing information to ensure that total amount is within the spending limit of the employee, the requested items are not restricted, and the quantities are within the limit set for the employee, for example. If any of the requested items are outside of the employee's purchasing authority, the central processing system 2 sets the status of the order to “unapproved.” The central processing system 2 then issues an e-mail message to the employee stating that the status of the order is unapproved and providing the reason the order was not approved. If the employee receives such an e-mail, step S4, he or she has the option to pursue the order as a non-standard order by going through human channels, step S6. That is, the employee gets the necessary approval from a superior and has the order placed by one of the organization's purchasing agents. The employee also has the option to modify the order and resubmit it for purchase, step S8.

If the requested items are within the employee's purchasing authority, then the central processing system accesses records of the employee's purchases from the memory 6 to determine whether the requested items are compatible with previous purchases, step S10. For example, as mentioned above, a request for a “Model B” telephone battery would not be approved if the employee's purchasing records show that a “Model A” cellular telephone was previously purchased and no “Model B” telephone has been purchased. Similarly, a request to purchase software for a MacIntosh® computer would not be approved if the records show that the employee has an IBM® computer. In such cases, the central processing system 2 sets the status of the order to “unapproved.” The central processing system 2 then issues an e-mail message to the employee stating that status of the order is unapproved and stating the reason the order was not approved. If the employee receives such an e-mail, step S4, he or she has the option to pursue the order as a non-standard order by going through human channels, step S6. That is, the employee gets the necessary approval from a superior and has the order placed by one of the organization's purchasing agents. The employee also has the option to modify the order and resubmit it for purchase, step S8.

Optionally, for orders placed by certain categories of employees, the central processing system 2 sends an e-mail message to an approval officer notifying him or her of a requested order and the order number. The approval officer then must input an approval to the central processing system 2. One or more levels of approval may be processed this way. This option may be useful for temporary employees, allowing them to prepare orders for purchase without giving them any real purchasing authority.

Once the order is approved, it is transmitted electronically to the vendors corresponding to the requested items. The electronic order is sent using known methods, such as EDI (Electronic Data Interchange), FTP (File Transfer Protocol), and XML (Extended Markup Language), and a record of the transmitted order is stored in the e-procurement system. As mentioned above, the organization's e-procurement system 1 is transparent to vendors, and the vendors merely receive the end product (orders) of the e-procurement system 1 without knowing how the orders were placed or processed.

In due course, after the order is partially or entirely fulfilled, the vendor electronically transmits an invoice to the organization via the Internet 4. The invoice is stored in a mailbox in the memory 6 of the central processing system 2. Optionally, the invoice may be stored in a memory of the organization's accounting department system 12, shown in FIG. 1. The electronic invoice is in a format readable by the central processing system 2. That is, the invoice is coded so that the central processing system 2 can recognize order numbers, order dates, product numbers, quantities, and other relevant information. The e-procurement system 1 then undergoes an automatic electronic reconciliation process, in which the invoice is compared with the record of the corresponding order, stored in the memory 6 of the central processing system 2, on an item by item basis.

If an invoice entry differs from the corresponding order entry, an electronic flag is attached to that entry, so that the organization's accounting department is automatically notified of the discrepancy when the invoice is processed. The status of the order then changes to “billing exceptions,” as discussed earlier, and the accounting department system 12 does not automatically remit payment for the order.

If the invoice entry matches the corresponding order entry, then the central processing system 2 verifies that the item has been received by checking whether the item has been logged by the organization's mailroom personnel as having been received. More specifically, when packages are received at any of the organization's mailrooms, the packing slips (shipping lists) from the packages are retrieved by a mailroom clerk. The clerk then identifies the order number from the packing slip, and accesses the e-procurement system 1 from a terminal, T, as shown in FIG. 1. The clerk modifies the record stored in the memory 6 of the central processing system 2 for that order, so that the items that have been received are identified. In turn, when the accounting department system 12 processes the invoice, payment is automatically remitted only for received items.

The e-procurement system 1 includes an asset management feature, in which a request for the purchase of equipment, such as personal computers, facsimile machines, and printers, for example, is first checked against a list of the organization's surplus inventory stored in the memory 6 of the central processing system 2. If the equipment is available as inventory, the requesting employee is notified by e-mail of the availability and asked whether transfer of the surplus item is acceptable. Processing of the order for the equipment is temporarily suspended. If the surplus item is acceptable, the employee transmits an e-mail response to that effect, and that item is transferred to the employee and canceled from the employee's order. If transfer of the surplus item is declined, the central processing system 2 continues processing the order as usual.

Optionally, if a requested item of equipment is available as inventory, the requesting employee is notified by e-mail of the availability, and is also notified that transfer of the equipment may not be declined, although the employee has the option of canceling that item from the order by notifying the organization's purchasing department. This option lets the organization control its expenditures, by minimizing unnecessary equipment purchases, which are relatively high-cost purchases compared with consumable office supplies such as paper and pens, for example. It is to be understood, however, that this option need not be limited to equipment, but may be used for any surplus item.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An electronic procurement system connected a network, the system enabling employees of an organization to electronically order goods and/or services directly from vendors, the system comprising:
an electronic memory storing a vendor's catalog of items available for purchase, the catalog being viewable at an employee's computer terminal via the network;
a transmitter operatively connected to the network and to an external network, the transmitter being arranged to electronically transmit a purchase order from the system to a vendor via the external network; and
a comparison unit,
wherein a record of the purchase order is stored in the memory of the system, and
wherein the comparison unit compares an electronically transmitted invoice received from the vendor via the external network with the record to determine whether there are any discrepancies.

2. The system according to claim 1, further comprising a payment authorization unit in electronic communication with a payment system in the organization's accounting department,
wherein, if no discrepancies are found between the record and the invoice, the payment authorization unit automatically approves payment of the invoice by the accounting department.

3. The system according to claim 1, further comprising a main control unit for controlling operation of the system, wherein changes to the system are made at the main control unit.

4. An electronic procurement system connected to a network, the system comprising:
an asset memory storing information relating to an organization's surplus inventory; and
an asset management unit that compares a request for an item in an electronic purchase order with a list of the organization's surplus inventory stored in the asset memory to determine whether there is a match.

5. The system according to claim 4, wherein, if a match is found between the request and the list of surplus inventory, a corresponding requester is notified of the match via the network.

6. The system according to claim 5, wherein, if the requester accepts transfer of the matched item, the request for the item is canceled from the electronic purchase order.

7. An electronic procurement method of an electronic procurement system, the method comprising:
a storage step of storing in an electronic memory of the system a vendor's catalog of items available for purchase, the catalog being viewable at an employee's computer terminal via a network;
a transmission step of electronically transmitting a purchase order to a vendor via an external network; and
a comparison step of comparing a record of the purchase order stored in a memory of the system with an electronically transmitted invoice received from the vendor via the external network to determine whether there are any discrepancies.

8. The method according to claim 7, further comprising a payment authorization step of automatically authorizing payment of the invoice if no discrepancies are found between the record and the invoice.

9. The method according to claim 7, further comprising a control step of controlling operation of the system such that changes to the system are made at a main control unit.

10. An electronic procurement method of an electronic procurement system connected to a network, the method comprising:
an asset information storage step of storing information relating to an organization's surplus inventory in a memory of the system; and
an asset management step of comparing a request for an item in an electronic purchase order with a list of the organization's surplus inventory stored in the memory of the system to determine whether there is a match.

11. The method according to claim 10, wherein, if a match is found between the request and the list of surplus inventory, a corresponding requester is notified of the match via the network.

12. The method according to claim 11, wherein, if the requester accepts transfer of the matched item, the request for the item is canceled from the electronic purchase order.

13. A computer-readable storage medium storing a program for implementing an electronic procurement method of a system connected a network, the system enabling employees of an organization to electronically order goods and/or services directly from vendors, the program comprising:
code for a storage step of storing in an electronic memory a vendor's catalog of items available for purchase, the catalog being viewable at an employee's computer terminal via the network;
code for a transmission step of electronically transmitting a purchase order from the system to a vendor via an external network; and
code for a comparison step of comparing a record of the purchase order stored in the memory of the system with an electronically transmitted invoice received from the vendor to determine whether there are any discrepancies.

14. The storage medium according to claim 13, wherein the program further comprises code for a payment authorization step of automatically authorizing payment of the invoice by the organization's accounting department if no discrepancies are found between the record and the invoice.

15. The storage medium according to claim 13, wherein the program further comprises code for a control step of controlling operation of the system such that changes to the system are made at a main control unit.

16. A computer-readable storage medium storing a program for implementing an electronic procurement method of an electronic procurement system connected to a network, the program comprising:
code for an asset information storage step of storing information relating to an organization's surplus inventory in a memory of the system; and
code for an asset management step of comparing a request for an item in an electronic purchase order with a list of the organization's surplus inventory stored in the memory of the system to determine whether there is a match.

17. The storage medium according to claim 16, wherein, if a match is found between the request and the list of surplus inventory, a corresponding requester is notified of the match via the network.

18. The storage medium according to claim 17, wherein, if the requester accepts transfer of the matched item, the request for the item is canceled from the electronic purchase order.

19. A computer program product embodying a program for implementing an electronic procurement method of an electronic procurement system connected to a network, the system enabling employees of an organization to electronically order goods and/or services directly from vendors, the program comprising:
code for a storage step of storing in an electronic memory a vendor's catalog of items available for purchase, the catalog being viewable at an employee's computer terminal via the network;
code for a transmission step of electronically transmitting a purchase order from the system to a vendor via the external network; and
code for a comparison step of comparing a record of the purchase order stored in the memory of the system with an electronically transmitted invoice received from the vendor to determine whether there are any discrepancies.

20. The program product according to claim 19, wherein the program further comprises code for a payment authorization step of automatically authorizing payment of the invoice by the organization's accounting department if no discrepancies are found between the record and the invoice.

21. The program product according to claim 19, wherein the program further comprises code for a control step of controlling operation of the system such that changes to the system are made at a main control unit.

22. A computer program product embodying a program for implementing an electronic procurement method of an electronic procurement system connected a network, the program comprising:
code for an asset information storage step of storing information relating to the organization's surplus inventory in a memory of the system; and
code for an asset management step of comparing a request for an item in an electronic purchase order with a list of the organization's surplus inventory stored in the memory of the system to determine whether there is a match.

23. The program product according to claim 22, wherein, if a match is found between the request and the list of surplus inventory, a corresponding requester is notified of the match via the network.

24. The program product according to claim 23, wherein, if the requester accepts transfer of the matched item, the request for the item is canceled from the electronic purchase order.

25. An electronic procurement system connected to a network, the system comprising:
an electronic memory storing a list of an employee's previous purchases;
a comparison unit that compares items in an electronic purchase order, which is submitted by the employee to the system via the network, with the list of the employee's previous purchases stored in the memory to determine whether any of the items is incompatible with a previously purchased item.

26. The system according to claim 25, wherein, if the comparison unit determines that an item is incompatible with a previously purchased item, a message is transmitted to the employee via the network notifying the employee of the incompatibility.

27. An electronic procurement method of an electronic procurement system connected to a network, the method comprising:
a storage step of storing a list of an employee's previous purchases in an electronic memory of the system;
a comparison step of comparing items in an electronic purchase order, which is submitted by the employee to the system via the network, with the list of the employee's previous purchases stored in the memory to determine whether any of the items is incompatible with a previously purchased item.

28. The method according to claim 27, wherein, if it is determined in the comparison step that an item is incompatible with a previously purchased item, a message is transmitted to the employee via the network notifying the employee of the incompatibility.

29. A computer-readable storage medium storing a program for implementing an electronic procurement method of an electronic procurement system connected to a network, the program comprising:
code for a storage step of storing a list of an employee's previous purchases in an electronic memory of the system;
code for a comparison step of comparing items in an electronic purchase order, which is submitted by the employee to the system via the network, with the list of the employee's previous purchases stored in the memory to determine whether any of the items is incompatible with a previously purchased item.

30. The storage medium according to claim 29, wherein, if it is determined in the comparison step that an item is incompatible with a previously purchased item, a message is transmitted to the employee via the network notifying the employee of the incompatibility.

31. A computer program product embodying a program for implementing an electronic procurement method of an electronic procurement system connected to a network, the program comprising:
code for a storage step of storing a list of an employee's previous purchases in an electronic memory of the system;
code for a comparison step of comparing items in an electronic purchase order, which is submitted by the employee to the system via the network, with the list of the employee's previous purchases stored in the memory to determine whether any of the items is incompatible with a previously purchased item.

32. The program product according to claim 31, wherein, if it is determined in the comparison step that an item is incompatible with a previously purchased item, a message is transmitted to the employee via the network notifying the employee of the incompatibility.
